(19) United States
(12) Patent Application Publication
(10) Pub. No.: US 2014/0314049 A1
(43) Pub. Date: Oct. 23, 2014

(54) METHOD AND APPARATUS FOR DEVICE TO DEVICE DIRECT COMMUNICATION IN CLOUD BASE STATION SYSTEM

(71) Applicant: Electronics and Telecommunications Research Institute, Daejeon-si (KR)

(72) Inventors: Eun Seon CHO, Daejeon (KR); Chan Yong LEE, Daejeon (KR); Hyeon Ju OH, Daejeon (KR); Byung Han RYU, Daejeon (KR); Nam Hoon PARK, Daejeon (KR)

(73) Assignee: Electronics and Telecommunications Research Institute, Daejeon-si (KR)

(21) Appl. No.: 14/242,246

(22) Filed: Apr. 1, 2014

(30) Foreign Application Priority Data
Apr. 19, 2013 (KR) 10-2013-0043318

(51) Int. Cl. H04W 36/30; H04W 28/18; H04L 5/00; H04W 72/08

(52) U.S. Cl. CPC H04W 36/30; H04W 72/085; H04W 28/18; H04L 5/006
USPC 370/332; 370/329

(57) ABSTRACT

Disclosed are a D2D direct communication method and apparatus in a cloud base station system. The present invention includes receiving a measurement result, including information about D2D proximity or interference from other devices, from each of a first device and a second device, determining whether or not to admit D2D direct communication between the first device and the second device based on the measurement results, sending radio resource information to a second base station and receiving radio resource information of the second base station if it is determined that the D2D direct communication is admitted, negotiating radio resources, allocated for the D2D direct communication, with the second base station using the internal primitive, and allocating radio resources to the first device based on the negotiation.

### CROSS-REFERENCE TO RELATED APPLICATIONS

This application claims priority to and the benefit of Korean Patent Application No. 10-2013-0043318, filed on Apr. 19, 2013, the entire contents of which is incorporated by reference herein.

### BACKGROUND OF THE INVENTION

1. Field of the Invention

The present invention relates to a cloud base station system and, more particularly, to a method and apparatus for a device in Device-to-Device (D2D) communication performing handover between cells.

2. Discussion of the Related Art

A cloud base station system in which several base stations are gathered at one place for the efficient operation and management of an operator is used.

A cloud base station system is a system that couples the Digital Unit (DU) of a base station and an RF unit using an optical cable and is useful for integrated cell operation and management between base stations.

In communication between base stations, a system-internal primitive not an X2 interface is used. Accordingly, an environment enabling rapid and efficient base station cooperation communication can be provided.

D2D direct communication refers to a communication method in which two adjacent devices directly transmit and receive data without through a base station. That is, the two devices become the respective source and destination of data and thus perform communication.

D2D direct communication may be performed according to a communication method using a non-licensed band, such as a WLAN such as IEEE 802.11, or Bluetooth. In the communication method using this non-licensed band, however, it is difficult to provide planned and controlled service. In particular, performance can be suddenly deteriorated by interference.

In contrast, in D2D direct communication operated or provided in a licensed band or an environment having controlled inter-system interference, Quality of Service (QoS) can be supported, frequency use efficiency can be increased through frequency reuse, and a possible communication coverage can be increased.

For D2D direct communication in this licensed band, that is, D2D direct communication based on cellular communication, a base station allocates resources to a device and the allocated resources can use a cellular uplink channel.

D2D direct communication includes D2D communication within a cell or D2D communication between cells. D2D direct communication between cells is possible based on only cooperation communication between two base stations and is difficult to be implemented.

### SUMMARY OF THE INVENTION

An object of the present invention is to provide a method and apparatus in which one of devices in direct communication within one cell performs handover to another base station.

Another object of the present invention is to perform D2D direct communication rapidly and efficiently using an internal primitive between base stations in a cloud base station.

In accordance with an aspect of the present invention, a method of a first base station performing handover in a cloud base station system includes receiving a measurement result for determining whether or not handover is necessary or a measurement result regarding D2D proximity from a device, recognizes that the device moves to the cell boundary of a second base station, requesting the handover of the device from the second base station using an internal primitive, receiving an admission of the handover for the device from the second base station using the internal primitive, and sending a handover command to the device.

In accordance with another aspect of the present invention, a method of a second base station performing handover in a cloud base station system includes receiving a request regarding the handover of a device from a first base station using an internal primitive, allocating cellular resources to the device, sending the admission of the handover for the device to the first base station using the internal primitive, and performing a cell access procedure along with the device using the cellular resources.

In accordance with yet another aspect of the present invention, a method of a first base station performing D2D communication in a cloud base station system includes receiving a measurement result, including information about D2D proximity or interference from other devices, from each of a first device and a second device, determining whether or not to admit D2D direct communication between the first device and the second device based on the measurement results, sending radio resource information to a second base station through an internal primitive and receiving radio resource information of the second base station from the second base station through the internal primitive if, as a result of the determination, it is determined that the D2D direct communication is admitted, negotiating radio resources, allocated for the D2D direct communication, with the second base station using the internal primitive, and allocating radio resources to the first device based on the negotiation.

In accordance with further yet another aspect of the present invention, a method of a second base station performing D2D communication in a cloud base station system includes receiving radio resource information of a first base station from the first base station through an internal primitive and sending radio resource information of the second base station to the first base station through the internal primitive, negotiating the allocation of radio resources for D2D direct communication with the first base station using the internal primitive, scheduling radio resources based on the negotiation, and allocating the scheduled radio resources to a first device.

### BRIEF DESCRIPTION OF THE DRAWINGS

FIG. 1 is a conceptual diagram illustrating a cloud base station system and Device-to-Device (D2D) direct communication to which the present invention;

FIG. 2 shows an example of a handover situation in D2D direct communication to which the present invention is applied;

FIG. 3 is a conceptual diagram illustrating an example of a cloud base station system which is applied to the present invention;

FIG. 4 is a diagram illustrating an example in which a device being in D2D direct communication performs a handover procedure in accordance with the present invention;

FIG. 5 is a flowchart illustrating an example of a method in which a device that has performed handover performs D2D direct communication in accordance with the present invention;

FIG. 6 is a flowchart illustrating another example of a method of performing D2D direct communication in accordance with the present invention; and

FIG. 7 shows an example of resources allocated for D2D direct communication in accordance with the present invention.

### DETAILED DESCRIPTION OF THE EMBODIMENTS

Hereinafter, embodiments of the present invention will be described in detail with reference to the accompanying drawings so that they can be readily implemented by those skilled in the art.

Hereinafter, some embodiments of the present invention are described in detail with reference to the accompanying drawings in order for a person having ordinary skill in the art to which the present invention pertains to be able to readily implement the invention. It is to be noted the present invention may be implemented in various ways and is not limited to the following embodiments. Furthermore, in the drawings, parts not related to the present invention are omitted in order to clarify the present invention and the same or similar reference numerals are used to denote the same or similar elements.

The objects and effects of the present invention can be naturally understood or become clear by the following description, and the objects and effects of the present invention are not restricted by the following description only.

The objects, characteristics, and merits will become more apparent from the following detailed description. Furthermore, in describing the present invention, a detailed description of a known art related to the present invention will be omitted if it is deemed to make the gist of the present invention unnecessarily vague. A preferred embodiment in accordance with the present invention is described in detail below with reference to the accompanying drawings.

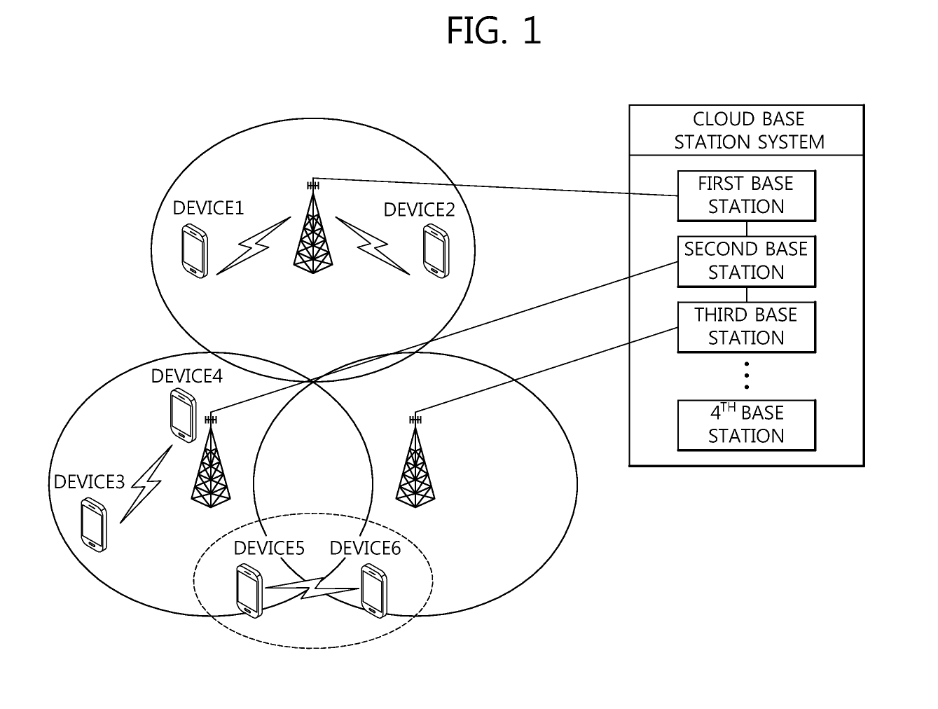

FIG. 1 is a conceptual diagram illustrating a cloud base station system and Device-to-Device (D2D) direct communication to which the present invention. The cloud base station system refers to a system in which several base stations are geographically gathered at one place. In the cloud base station system, each base station manages cells allocated thereto.

Referring to FIG. 1, a first device and a second device perform cellular communication through a first base station in the cell area of the first base station (also called a cell area covered by the first base station).

A third device and a fourth device directly perform data communication. That is, communication is performed without through a base station. The third device and the fourth device perform D2D direct communication within the same serving cell.

A fifth device and a sixth device directly perform data communication. That is, communication is performed without through a base station. The fifth device and the sixth device within different serving cells perform direct communication.

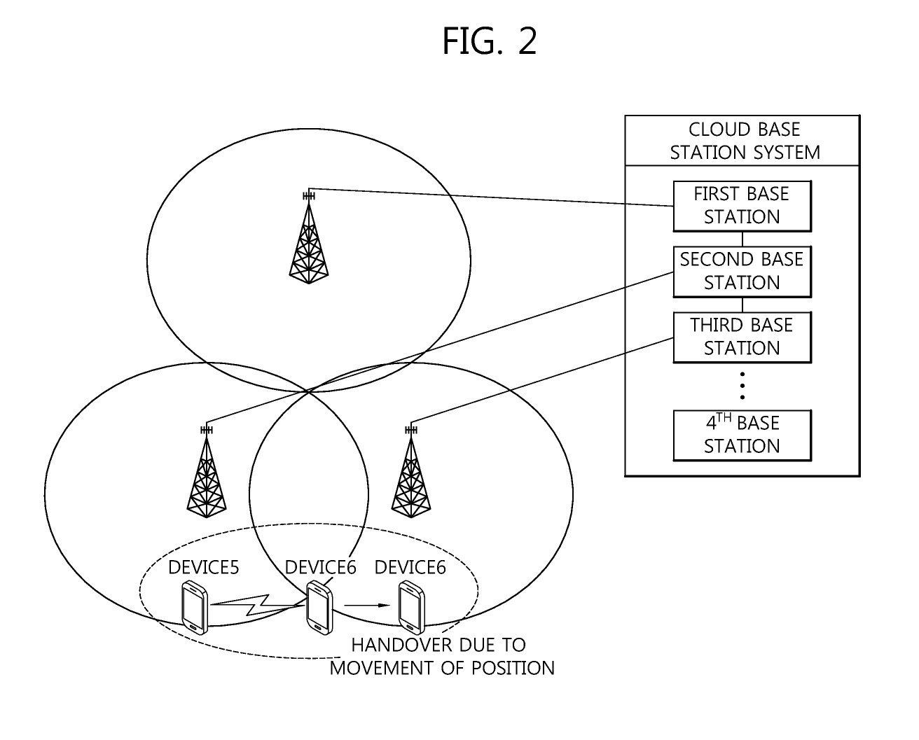

FIG. 2 shows an example of a handover situation in D2D direct communication to which the present invention is applied.

Referring to FIG. 2, while a fifth device and a sixth device perform D2D direct communication within the area of the same serving cell (or the serving cell of a second base station), the sixth device moves to the cell area of a third base station.

For example, there is a method of switching from direct communication between the fifth device and the sixth device to cellular communication through a base station. D2D direct communication can switch to cellular communication through a base station because a default bearer has been set up between a device and the base station.

For another example, there is a method of continuing to perform D2D direct communication by changing a serving cell when a sixth device being in motion performs handover to the third base station. In particular, this method is useful when the fifth device and the sixth device are close to each other even after the handover.

For yet another example, there is a method of automatically terminating the connection of D2D direct communication when proximity between terminals in D2D direct communication is increased.

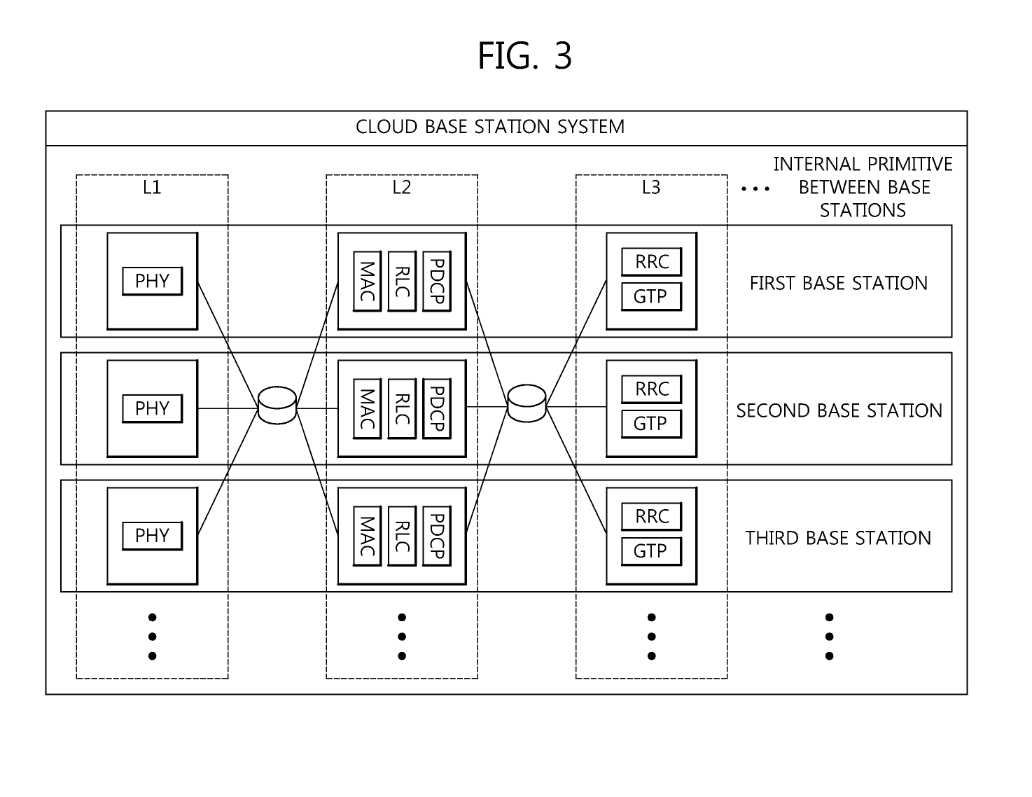

FIG. 3 is a conceptual diagram illustrating an example of a cloud base station system which is applied to the present invention.

Referring to FIG. 3, the cloud base station system is a system in which several common base stations are gathered at one place and is also called a centralized station, a centralized station system, or a cloud system.

The cloud base station system can perform integrated cell functions difficult to be implemented between common base stations that are geographically spaced apart from each other.

In the cloud base station system, an internal primitive between Radio Resource Control (RRC) and Media Access Control (MAC), that is, protocols within a base station, and RRC and MAC, that is, protocols within another base station, can be defined, cooperative communication between base stations, such as Cooperative Multi Point (CoMP), a carrier aggregation, and Inter-Cell Interference Coordination (ICIC), can be implemented.

The cloud base station system can implement functions rapidly and efficiently using the internal primitive without using an X2 interface.

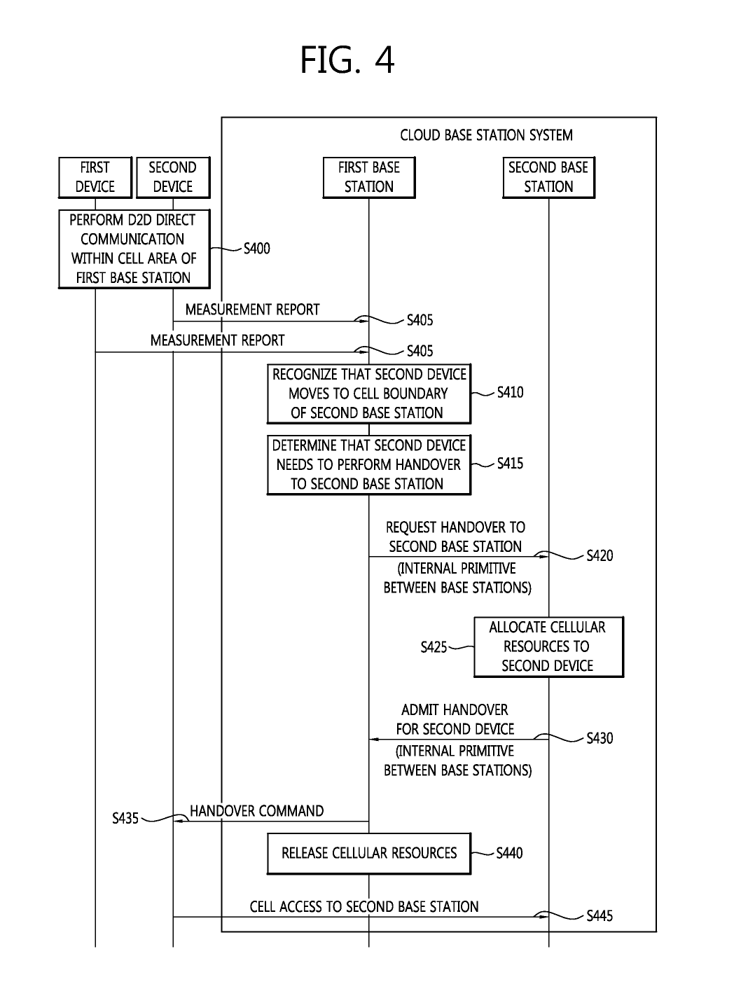

FIG. 4 is a diagram illustrating an example in which a device being in D2D direct communication performs a handover procedure in accordance with the present invention.

Referring to FIG. 4, a first device and a second device performs D2D direct communication within the cell area of a first base station at step S400.

The first device and the second device perform measurement for determining whether or not to perform handover and perform measurement for determining D2D proximity and send respective measurement reports to the first base station at step S405. The measurement report can be a periodic measurement report or an event-triggered measurement report.

The first base station recognizes that the second device moves to the boundary of the cell of a second base station at step S410.

The first base station determines that the second device needs to perform handover to the second base station at step S415.

The first base station requests the handover of the second device to the second base station using an internal primitive between the base stations at step S420.

The second base station allocates cellular resources to the second device at step S425.

The second base station sends the admission of the handover for the second device to the first base station using the internal primitive between the base stations at step S430.

The first base station sends a handover command to the second device at step S435. The handover command (or a message including the handover command) can include information about the cellular resources allocated by the second base station, and the second device can access the second base station based on the information about the cellular resources.

The first base station releases the cellular resources allocated to the second device at step S440.

The second device performs a cell access procedure on the second base station and changes a serving cell from the first base station to the second base station at step S445.

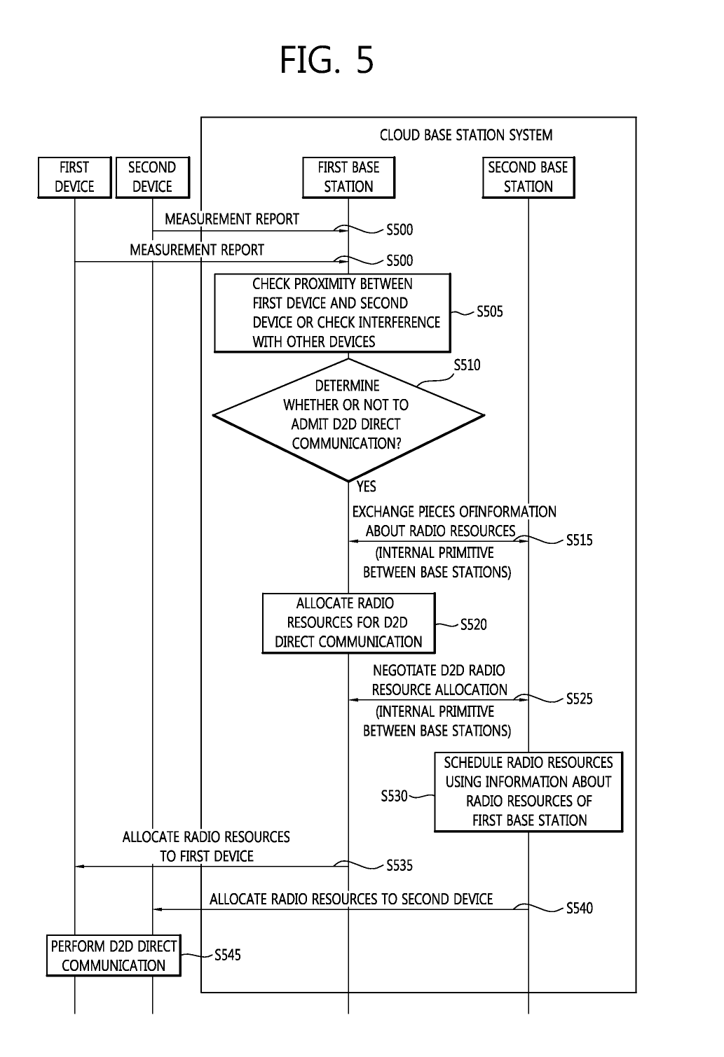

FIG. 5 is a flowchart illustrating an example of a method in which a device that has performed handover performs D2D direct communication in accordance with the present invention. The example of FIG. 5 is an example in which a first device and a second device which have performed handover using a procedure, such as that of FIG. 4, performs D2D direct communication using resources allocated by a first base station.

Referring to FIG. 5, the first device and the second device report measurement results to the first base station at step S500.

The report can be a periodic measurement report or an event-triggered measurement report.

The measurement results can include information about proximity between the first device and the second device or interference from other devices.

The first base station checks proximity between the first device and the second device or interference with other devices based on the measurement reports at step S505.

The first base station determines whether or not to continuously admit D2D direct communication between the first device and the second device at step S510.

If, as a result of the determination, it is determined that the first base station admits D2D direct communication, the first base station and a second base station exchange pieces of information about their radio resources using an internal primitive between the base stations at step S515.

The first base station allocates radio resources for the D2D direct communication at step S520.

The first base station and the second base station perform a D2D radio resource allocation negotiation using the internal primitive between the base stations at step S525. The D2D radio resource allocation refers to the allocation of radio resources for the D2D direct communication.

When the D2D radio resource allocation negotiation is completed, the second base station schedules its radio resources using information about the radio resources of the first base station at step S530.

For example, the second base station can perform scheduling so that radio resources corresponding to the radio resources allocated by the first base station are empty from its own resources.

The first base station allocates radio resources for the D2D direct communication to the first device at step S535, and the second base station allocates radio resources for the D2D direct communication to the second device at step S540.

The first device and the second device to which the radio resources have been allocated perform D2D direct communication at step S545.

Accordingly, the first device served by the first base station and the second device served by the second base station can perform D2D direct communication.

That is, even after the second device has performed handover to the second device served by the first base station receives service from the second base station, the second device can perform D2D direct communication with the first device served by the first base station.

If, as a result of the determination at step S510, it is determined that the first base station does not admit D2D direct communication, the first device and the second device may terminate D2D direct communication or switch back to cellular communication.

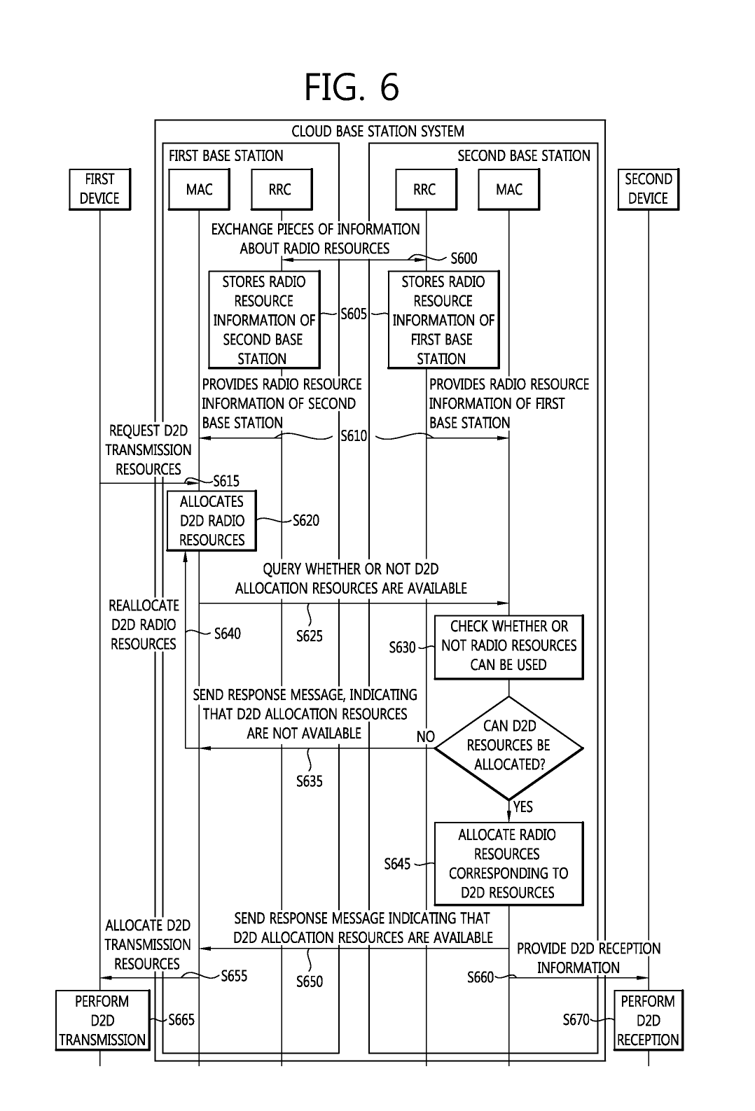

FIG. 6 is a flowchart illustrating another example of a method of performing D2D direct communication in accordance with the present invention. The method of FIG. 5 is described in more detail below. A base station uses MAC and RRC, that is, internal protocols.

Referring to FIG. 6, the RRC of a first base station and the RRC of a second base station exchange pieces of information about radio resources at step S600. The information about radio resources can include a frequency band or a D2D frequency band used in the two base stations.

Each of the first and the second base station stores the exchanged radio resource information at step S605 and transfers the radio resource information to MAC (or the scheduler of the MAC), that is, the lower protocol of the RRC at step S610.

If a first device tries to send its own data to a second device, the first device requests D2D transmission resources from the MAC of the first base station at step S615. The D2D transmission resources refer to radio resources used for transmission in D2D direct communication.

The MAC of the first base station allocates available D2D radio resources at step S620. For example, the first base station can perform scheduling so that resources corresponding to the available D2D radio resources are empty. For another example, the first base station can select a plurality of radio resources. A probability that the same resources as that of the second base station can be allocated based on the plurality of radio resources can be increased.

The MAC of the first base station queries the MAC of the second base station whether or not D2D allocation resources, that is, its selected radio resources, are available at step S625.

The MAC of the second base station checks whether or not the radio resources received from the MAC of the first base station can be used in its own radio resources at step S630. That is, the MAC of the second base station determines whether or not all the radio resources selected by the first base station are already being used.

If, as a result of the determination, it is determined that all the radio resources selected by the first base station are already being used, the MAC of the second base station sends a response message, indicating that the D2D allocation resources of the first base station are not available, to the MAC of the first base station at step S635. In response to the response message, the

MAC of the first base station allocates D2D resources again at step S640 and performs the procedures corresponding to the steps S620 to S630.

If, as a result of the determination, it is determined that all the radio resources selected by the first base station are not being used (i.e., if available resources are present from among the radio resources selected by the first base station), the MAC of the second base station allocates its own radio resources corresponding to available resources, from among the resources selected by the first base station at step S645.

The MAC of the second base station sends a response message, indicating that the D2D allocation resources are available, to the MAC of the first base station at step S650. The response message can include information indicative of the available resources, from among the plurality of radio resources.

In response to the response message, the MAC of the first base station allocates D2D transmission resources to the first device at step S655.

The MAC of the second base station provides D2D reception information to the second device at step S660, the first device performs D2D transmission at step S665, and the second device performs D2D reception at step S670. That is, D2D direct communication is enabled.

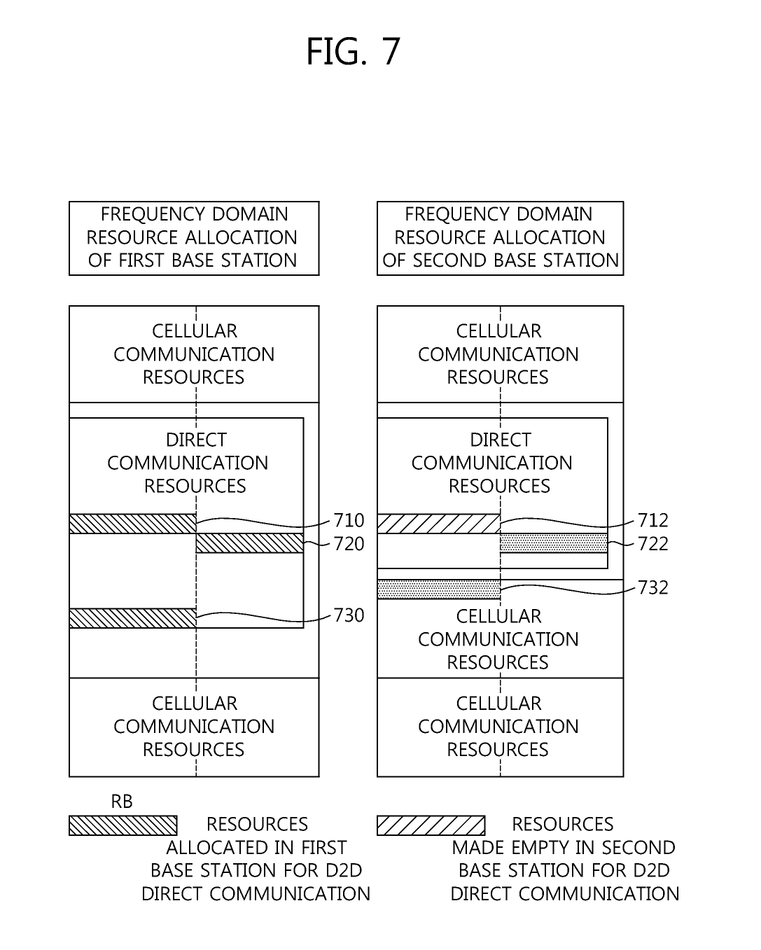

FIG. 7 shows an example of resources allocated for D2D direct communication in accordance with the present invention. For example, it is assumed that base stations use the same frequency band.

Referring to FIG. 7, a first base station allocates available resources 710, 720, and 730 in its own frequency domain and requests a second base station to selected at least one of the resources 710, 720, and 730.

The second base station checks its own frequency domain, selects available resources 712 from resources 712, 722, and 732, allocates the selected resources 712, and informs the first base station of the allocated resources so that the same radio resources can be allocated in base stations. That is, from among the resources of the frequency domain of the second base station, the resources 712, correspond to an area where the resources 712 can be allocated, the resources 722 correspond to an area where the resources 722 cannot be allocated because they are used as other D2D resources, and the resources 732 correspond to an area where the resources 732 cannot be allocated because they are used as cellular resources.

In accordance with the present invention, pieces of information about radio resources allocated for D2D direct communication between base stations can be exchanged rapidly and efficiently.

In accordance with the present invention, D2D direct communication between cells can be smoothly performed while a device performs handover to another cell.

A person having ordinary skill in the art to which the present invention pertains may change and modify the present invention in various ways without departing from the technical spirit of the present invention. Accordingly, the present invention is not limited to the above-described embodiments and the accompanying drawings.

In the above exemplary system, although the methods have been described based on the flowcharts in the form of a series of steps or blocks, the present invention is not limited to the sequence of the steps, and some of the steps may be performed in a different order from that of other steps or may be performed simultaneous to other steps. Furthermore, those skilled in the art will understand that the steps shown in the flowchart are not exclusive and the steps may include additional steps or that one or more steps in the flowchart may be deleted without affecting the scope of the present invention.

What is claimed is:

1. A method of a first base station performing handover in a cloud base station system, the method comprising:
receiving a measurement result for determining whether or not handover is necessary or a measurement result regarding Device-to-Device (D2D) proximity from a device;
recognizes that the device moves to a cell boundary of a second base station;
requesting the handover of the device from the second base station using an internal primitive;
receiving an admission of the handover for the device from the second base station using the internal primitive; and
sending a handover command to the device.

2. The method of claim 1, wherein the admission of the handover or the handover command comprises information about cellular resources allocated to the device by the second base station.

3. The method of claim 1, further comprising releasing cellular resources allocated to the device.

4. A method of a first base station performing Device-to-Device (D2D) communication in a cloud base station system, comprising:
receiving a measurement result, comprising information about D2D proximity or interference from other devices, from each of a first device and a second device;
determining whether or not to admit D2D direct communication between the first device and the second device based on the measurement results;
sending radio resource information to a second base station through an internal primitive and receiving radio resource information of the second base station from the second base station through the internal primitive if, as a result of the determination, it is determined that the D2D direct communication is admitted;
negotiating radio resources, allocated for the D2D direct communication, with the second base station using the internal primitive; and
allocating radio resources to the first device based on the negotiation.

5. The method of claim 4, wherein negotiating the radio resources comprises:
allocating radio resources for the D2D direct communication;
querying the second base station whether the allocated radio resources are available for the second base station; and
receiving a response, indicating that the allocated radio resources are available for the second base station, from the second base station.

6. The method of claim 5, wherein:
the allocated radio resources comprise a plurality of radio resources, and
the response comprises information indicative of available resources from among the plurality of radio resources.

7. The method of claim 4, further comprising terminating the D2D direct communication or switching back to cellular communication, if, as a result of the determination, it is determined that the D2D direct communication is not admitted.

8. A method of a second base station performing Device-to-Device (D2D) communication in a cloud base station system, comprising:
receiving radio resource information of a first base station from the first base station through an internal primitive and sending radio resource information of the second base station to the first base station through the internal primitive;
negotiating an allocation of radio resources for D2D direct communication with the first base station using the internal primitive;
scheduling radio resources based on the negotiation; and
allocating the scheduled radio resources to a first device.

9. The method of claim 8, wherein negotiating the allocation of the radio resources comprises:
receiving a query regarding whether or not radio resources allocated by the first base station for the D2D direct communication are available for the second base station from the first base station;
checking whether or not the radio resources allocated by the first base station for the D2D direct communication are available; and
sending a response, indicating that the radio resources allocated by the first base station for the D2D direct communication are available, to the first base station, if, as a result of the check, the radio resources allocated by the first base station for the D2D direct communication are available,
wherein the scheduled radio resources are available radio resources from among the radio resources allocated by the first base station for the D2D direct communication.

10. The method of claim 9, wherein:
the radio resources allocated by the first base station for the D2D direct communication comprise a plurality of radio resources, and
the response comprises information indicative of available resources from among the plurality of radio resources.
